(19) United States
(12) Patent Application Publication
(10) Pub. No.: US 2004/0209684 A1
(43) Pub. Date: Oct. 21, 2004

(54) Method of controlling game system, program, information storage medium and game system

(75) Inventor: Osamu Hisano, Setagaya-ku (JP)

Correspondence Address: OLIFF & BERRIDGE, PLC, P.O. BOX 19928, ALEXANDRIA, VA, 22320, US

(73) Assignee: NAMCO LTD., Ota-ku (JP)

(21) Appl. No.: 10/683,265

(22) Filed: Oct. 14, 2003

(30) Foreign Application Priority Data
Oct. 15, 2002 (JP) 2002-300297

(51) Int. Cl. A63F 13/00

(52) U.S. Cl. 463/32

(57) ABSTRACT

A three-dimensional role playing game system, a program and information storage medium which can be enjoyed even by a person weak in action games in such a manner similar to the action games. The three-dimensional role playing game system includes a target-character select mode processing section which determines a target character which is a target of battle of a player character based on select information for selecting the target character, and a battle mode processing section which controls a battle against or movement toward the determined target character by the player character. The three-dimensional role playing game system determines a route connecting the player and target characters, and interactively controls the player character to perform game actions on the route, based on operational input information. The three-dimensional role playing game system controls the placement of a virtual camera depending on the route.

Japanese Patent Application No. 2002-300297, filed on Oct. 15, 2002, is hereby incorporated by reference in its entirety.

### BACKGROUND OF THE INVENTION

The present invention relates to a method of controlling a game system, a program, an information storage medium and a game system.

A three-dimensional action game is configured to perform the movements and actions of a player character freely in a three-dimensional space for battling against an enemy character through input operation from a player. Thus, the player can enjoy a battle with the enemy by interactively controlling the player character through the player's control input.

On the contrary, many role playing games (which will be referred “RPGs”) are of such a type that after a target has been selected, a series of actions are automatically executed so that a player character attacks a selected enemy character.

In such a type of RPGs, the player does not almost have a room for interfering in the movements and actions of the player character in the battle scene after the target has been selected. Thus, the player only sees the progress of the game. This raises a problem in that the battle scenes in the RPGs become flat in comparison with the action games wherein the player character can interactively be controlled for battle.

If a three-dimensional RPG is designed to control the movements and actions of a player character freely as in the action games, however, this raises another problem in that a person weak in the action games cannot enjoy that RPG. For a player inexperienced in the action games, it is very difficult even to move a player character toward a target character in the three-dimensional space, for example.

### SUMMARY

(1) According to a first aspect of the present invention, there is provided a method of controlling a game system for a three-dimensional role playing game in which a plurality of characters including a player character appear, the method comprising:

receiving select information of a target character which is a target of battle or a target of movement for the player character to determine the target character based on the select information;

controlling an action of the player character to battle against or to move toward the determined target character; and

generating a game image in which the player character and the target character are shown;

wherein the step of controlling an action of the player character includes:

determining a route connecting the player character and the target character within a three-dimensional game space; and

receiving operational input information for controlling a game action of the player character, and interactively controlling a game action of the player character based on the operational input information so that the player character performs a game action on the route.

(2) According to a second aspect of the present invention, there is provided a program capable of causing a computer to perform a three-dimensional role playing game in which a plurality of characters including a player character appear, the program causing the computer to implement:

a target character determination section which receives select information of a target character which is a target of battle or a target of movement for the player character to determine the target character based on the select information;

a player character action control section which controls an action of the player character to battle against or to move toward the determined target character; and

an image generation section which generates a game image in which the player character and the target character are shown,

wherein the player character action control section includes:

a route determination section which determines a route connecting the player character and the target character within a three-dimensional game space; and

a game action control section which receives operational input information for controlling a game action of the player character, and interactively controls a game action of the player character based on the operational input information so that the player character performs a game action on the route.

(3) According to a third aspect of the present invention, there is provided a computer-readable information storage medium storing the above-described program.

(4) According to a fourth aspect of the present invention, there is provide a game system for a three-dimensional role playing game in which a plurality of characters including a player character appear, the game system comprising:

a target character determination section which receives select information of a target character which is a target of battle or a target of movement for the player character to determine the target character based on the select information;

a player character action control section which controls an action of the player character to battle against or to move toward the determined target character; and

an image generation section which generates a game image in which the player character and the target character are shown,

wherein the player character action control section includes:

a route determination section which determines a route connecting the player character and the target character within a three-dimensional game space; and

a game action control section which receives operational input information for controlling a game action of the player character, and interactively controls a game action of the player character based on the operational input information so that the player character performs a game action on the route.

### BRIEF DESCRIPTION OF THE SEVERAL VIEWS OF THE DRAWING

FIG. 1 is a block diagram showing an example of a game system according to one embodiment of the present invention.

FIG. 2 is a diagram for illustrating the selection of a target character according to one embodiment of the present invention.

FIG. 3 is a diagram for illustrating features of one embodiment of the present invention.

FIG. 4 is a diagram for illustrating placement control of the virtual camera according to one embodiment of the present invention.

FIG. 5 is a diagram for illustrating a placement example of the virtual camera according to one embodiment of the present invention.

FIGS. 6A and 6B are diagrams for illustrating zooming processing of the virtual camera according to one embodiment of the present invention.

FIGS. 7A and 7B are diagrams showing examples of game images when the zooming processing is performed according to one embodiment of the present invention.

FIGS. 8A and 8B are diagrams for illustrating placement control of the virtual camera in a select mode.

FIG. 9 is a diagram showing an example of a route connecting a player character and a target character according to one embodiment of the present invention.

FIG. 10 is a diagram showing another example of a route connecting a player character and a target character according to one embodiment of the present invention.

FIG. 11 is a flow chart for illustrating processing according to one embodiment of the present invention.

FIG. 12 is a flow chart for illustrating the placement control of the virtual camera according to one embodiment of the present invention.

FIG. 13 is a flow chart for illustrating action control of the virtual camera in a battle mode according to one embodiment of the present invention.

FIG. 14 is a block diagram showing the hardware configuration for implementing one embodiment of the present invention.

FIGS. 15A, 15B and 15C show various system forms to which embodiments of the present invention can be applied.

### DETAILED DESCRIPTION OF THE EMBODIMENT

1. Features of the Embodiments

(1) According to one embodiment of the present invention, there is provided a game system for a three-dimensional role playing game in which a plurality of characters including a player character appear, the game system comprising:

target character determination means which receives select information of a target character which is a target of battle or a target of movement for the player character to determine the target character based on the select information;

player character action control means which controls an action of the player character to battle against or to move toward the determined target character; and

image generation means which generates a game image in which the player character and the target character are shown,

wherein the player character action control means includes:

route determination means which determines a route connecting the player character and the target character within a three-dimensional game space; and

game action control means which receives operational input information for controlling a game action of the player character, and interactively controls a game action of the player character based on the operational input information so that the player character performs a game action on the route.

According to one embodiment of the present invention, there is provided a program which can be implemented by a computer (or a program which can be embodied on an information storage medium or in a carrier wave), and the program causes a computer to implement the aforementioned means (or causes a computer to function as the aforementioned means). Moreover, according to one embodiment of the present invention, there is provided a computer-readable (or computer usable) information storage medium, and the information storage medium includes a program which causes a computer to implement the aforementioned means (or causes a computer to function as the aforementioned means).

The target character may be selected from a plurality of characters in the game space, such as an enemy character or a friend character.

The battle or movement actions may include a battle action against a target character, movement toward a target character for a given objective, and communication, for example.

The route connecting the player character and the target character within the three-dimensional game space may be either of a straight line or a curved line so far as it can connect them.

The route connecting the player character and the target character may be determined based on positional information of the player and target characters in the last frame and the positional information of the player character may be used so that a new position of the player character is determined to be at a point on that route.

The selecting operation of a target character may include only a selecting action or may require some confirmation action after the selection. In the latter case, a route connecting the player and target characters within the three-dimensional game space can be determined after the confirmation.

In the three-dimensional role playing game according to this embodiment, operational input information for controlling the game actions of the player character is received, and then the operational input information is used to control the interactive movements and actions of the player character on the route.

The operational input information for controlling the game actions may include the execution of various actions (e.g., attack action), the execution of additional actions, the control of moving speed, the cancellation of target character and so on.

Input operation for controlling the movement route of the player character is difficult when the character can freely move within the three-dimensional space.

In this embodiment, however, since the movement of the player character is automatically controlled by the system when the player character moves on the route connecting the player character and the target character, it is not required for the player to control the movement route of the player character.

Thus, any advanced operating technique for controlling the movement route of the player character within the three-dimensional space is not required. This can provide a three-dimensional role playing game in which even a player who is weak in the operation of action game can enjoy the game and concentrate on the execution of various actions such as attack, the execution of additional actions, the control of movement speed and so on.

(2) In each of the game system, program and information storage medium according to the embodiment of the present invention,

as an operational input for controlling a game action of the player character, an operational input for a predetermined attack or motion, cancellation of an attack or motion, or addition of an attack or motion may be received; and a game action of the player character may be interactively controlled based on the received operational input so that the player character performs a predetermined attack or motion, cancellation of an attack or motion, or addition of an attack or motion on the route.

(3) Each of the game system, program and information storage medium according to the embodiment of the present invention may further comprise:

virtual camera placement control means for acquiring positions of the player character and the target character in real time and for controlling placement of a virtual camera based on the acquired positions of the player character and the target character.

In role playing games (which will be referred to “RPGs”) of such a type that a series of actions including movements and attacks of a player character to and against a target character are automatically implemented immediately after that target character has been selected, inputs from the player have no effect on the positional relationship between the player character and the target character. Therefore, it is not necessary to make the inputs from the player influence on the control of a virtual camera in such a game.

In this embodiment, however, the position of the player character on the route interactively changes depending on the inputs from the player.

According to this embodiment, the position of the player character which changes interactively can influence on the control of the virtual camera.

The virtual camera placement control means may control the placement of the virtual camera so that it gradually moves.

The virtual camera placement control means may determine the orientation of the virtual camera while moving the position of the virtual camera.

(4) Each of the game system, program and information storage medium according to the embodiment of the present invention may further comprise:

virtual camera placement control means for controlling placement of a virtual camera based on information of the route connecting the player character and the target character.

According to this embodiment, the route connecting the player character which changes interactively and the target character can reflect the control of the virtual camera

(5) In each of the game system, program and information storage medium according to the embodiment of the present invention,

the virtual camera placement control means may calculate positional information of the virtual camera so that the virtual camera is disposed at a position in which the player character and the target character are easily viewed by the virtual camera.

A position in which the player character and the target character are easily viewed may be a predetermined point on a straight line which orthogonally intersect a line segment connecting the player and target characters at the midpoint of the line segment. Alternatively, the position may be a point on a movement route of the virtual camera when a predetermined point on the straight line is a goal of the movement.

The position may be a point from which the movement route of the virtual camera can be viewed.

(6) In each of the game system, program and information storage medium according to the embodiment of the present invention,

the virtual camera placement control means may calculate a distance between the player character and the target character based on positional information of the player character and the target character, and zooming is performed depending on the distance.

The zooming may be performed so that the virtual camera moves toward the player and target characters when the distance between the player and target characters decreases or the virtual camera moves apart from the player and target characters when the distance increases.

(7) In each of the game system, program and information storage medium according to the embodiment of the present invention,

the virtual camera placement control means may calculate positional information of a virtual camera so that the virtual camera is disposed at a position in which all selectable characters are viewed by the virtual camera when a target character is selected.

(8) In each of the game system, program and information storage medium according to the embodiment of the present invention,

the route may be set as a straight line connecting the player character and the target character within the three-dimensional game space.

(9) In each of the game system, program and information storage medium according to the embodiment of the present invention,

when an obstacle exists between the player character and the target character within the three-dimensional game space, the route may be set to avoid the obstacle.

The route set to avoid the obstacle may be one that is set to actually avoids the obstacle, not to contact the obstacle or to pass around the obstacle.

For example, the minimum route avoiding the obstacle may be set.

(10) In each of the game system, program and information storage medium according to the embodiment of the present invention,

when height difference exists between the player character and the target character within the three-dimensional game space, the route may be set to reflect the height difference.

If there is a ground level difference between the player and target characters, for example, the route may be set considering the ground level difference.

2. Configuration

The embodiments of the present invention will be described with reference to the drawing.

Note that the embodiments described below do not in any way limit the scope of the invention laid out in the claims herein. In addition, all of the elements of the embodiments described below should not be taken as essential requirements of the present invention.

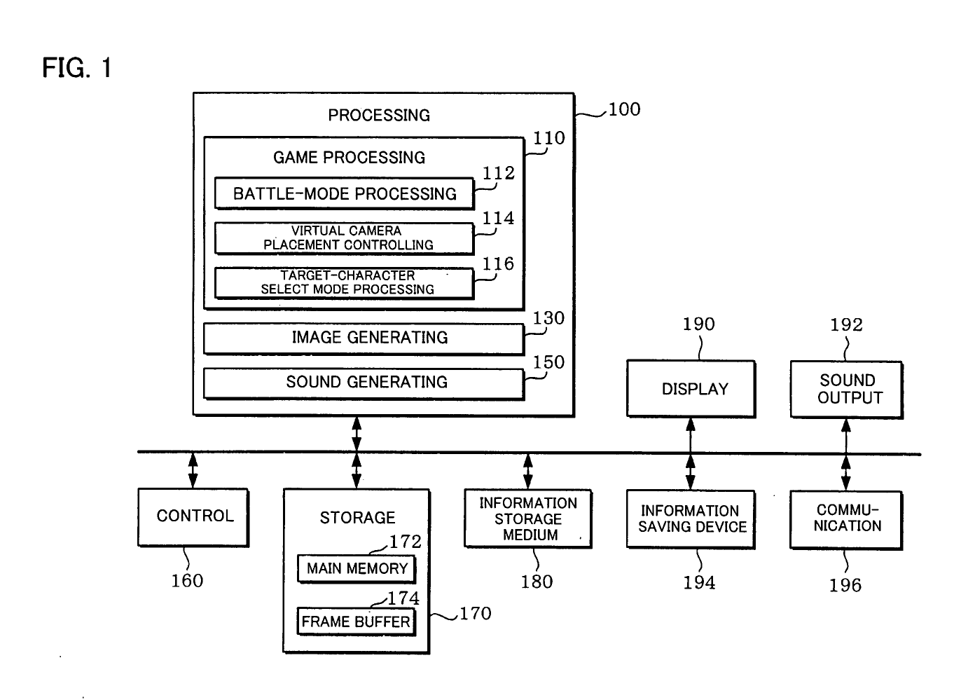

FIG. 1 shows a block diagram showing one embodiment of the present invention. In this figure, this embodiment requires a processing section 100 while the other blocks show optional components.

The processing section 100 performs various types of processing including control of the entire system, instructions to the blocks in the system, game processing, image processing, sound processing and so on. The function of the processing section 100 can be implemented by hardware such as various processors (CPU, DSP and the like) or ASIC (gate array or the like) or a program (or game program).

An operating section 160 is used by a player to input operational data, and its function can be implemented by hardware such as levers, buttons and housings.

A storage section 170 is used as work regions for the processing section 100, a communications unit 196 and so on, and functions as a main memory 172 and a frame buffer (having a first frame buffer and a second frame buffer) 174, its function being able to be implemented by RAM or the like.

An information storage medium (computer-usable storage medium) 180 stores programs and information such as data, and its function can be implemented by hardware such as a optical disc (CD or DVD), a magnetic optical disc (MO), a magnetic disc, a hard disc, a magnetic tape or a memory (ROM). The processing section 100 performs various types of processing based on the information stored in the information storage medium 180. That is to say, the information storage medium 180 stores information (or a program or data) used to implement the means (particularly, components in the processing section 100) according to the embodiments of the present invention.

Part or the whole part of the information stored in the information storage medium 180 will be transferred to the storage section 170 when the system is initially powered on. The information stored in the information storage medium 180 includes at least one selected from a group consisting of a program code for performing the processing of the present invention, image data, sound data, shape data of displayed matters, table data, list data, information for instructing the processing of the present invention, information for performing that processing according to the instructions and so on.

A display section 190 outputs images generated according to the embodiments of the present invention, its function being able to be implemented by hardware such as CRT, LCD or HMD (head-mount display).

A sound output section 192 outputs sounds generated according to the embodiments of the present invention, its function being able to be implemented by hardware such as a loud speaker.

An information saving device 194 stores a player's personal data (or data to be saved) or the like. This information saving device 194 may be any one of memory cards and mobile game machines.

A communications unit 196 performs various controls for performing a communication between the system of the present invention and an external system (e.g., a host machine or other game systems), its function being able to be implemented by hardware such as various processors or communicating ASIC or by a program.

The program or data used to implement the means of the embodiments of the present invention may be delivered from an information storage medium included in a host machine (or server) to the information storage medium 180 through a network and the communication section 196. Use of the information storage medium in such a host machine (or server) is also included within the scope of the present invention.

The processing section 100 includes game processing section 110, an image generating section 130 and a sound generating section 150.

The game processing section 110 performs various types of processing such as processing for receiving coins (or charges), processing for setting various modes, processing for progressing a game, processing for setting a selection scene, processing for determining the position of an object (consisting of one or more primitive faces) and the rotational angle of the object (about X-, Y- or Z-axis), processing for causing the object to act (motion processing), processing for determining the position of viewpoint (or the position of the virtual camera) or the angle of sight line (or the rotational angle of the virtual camera), processing for arranging an object such as a map object in an object space, hit checking processing, processing for computing the results of a game (product and score), processing for permitting a plurality of players to play in a common game space or a game-over processing, based on the operational data from the operating section 160, the personal data from the information saving device 194 and the game program.

The game processing section 110 also includes a battle mode processing section 112, a virtual camera placement controlling section 114, and a target-character select mode processing section 116.

The target-character select mode processing section 116 receives select information for selecting a target character to be attacked or approached by a player character and determines the desired target character based on the select information.

The battle mode processing section 112 controls the attack or approach of the player character against the determined target character and functions as a player-character operating and controlling means.

The battle mode processing section 112 also performs a processing for determining a route connecting the player and target characters within the three-dimensional game space, and a control processing for receiving operational input information used to control the game action of the player character and for interactively causing the player character to perform the game action on the route based on the operational input information.

The virtual camera placement controlling section 114 acquires the positions of the player and target characters in real time and controls the placement of the virtual camera based on these acquired positions.

The virtual camera placement controlling section 114 may control the placement of the virtual camera based on the information relating to the route connecting the player and target characters.

The positional information of the virtual camera may be computed so that the virtual camera is disposed at a position in which both the player and target characters can easily be viewed by the virtual camera.

A zooming may be carried out depending on the distance between the player and target characters, which distance has been computed based on the positional information relating to both the player and target characters.

When a target character is selected, the positional information of the virtual camera may be computed so that the virtual camera will be disposed at a position where all the selectable characters are viewed.

According to instructions from the game processing section 110, the image generating section 130 performs coordinate transformation, clipping processing, perspective transformation and geometry-processing (three-dimensional operations) such as light source calculation and various types of image processing such as a process of drawing a geometry-processed object (or model) into a frame buffer, and then generates an image viewable from the virtual camera (or a viewpoint) within the object space, which image is in turn outputted toward the display section 190.

According to the instructions from the game processing section 110, the sound generating section 150 performs various types of sound processing to generate BGMs, sound effects and voices which are in turn outputted toward the sound output section 192.

The functions of the game processing section 110, image generating section 130 and sound generating section 150 may be implemented wholly through hardware or a program. Alternatively, they may be implemented through both the hardware and program.

The game system of this embodiment may be dedicated for a single-player mode in which only a single player can play a game or may have a multi-player mode in which a plurality of players can play a game simultaneously.

If a plurality of players play the game, one single terminal may be used to generate game images and game sounds to be provided to these players. Alternatively, these game images and sounds may be generated through a plurality of terminals which are interconnected through a network (transmission line or telecommunication line).

The features of this embodiment will be described with reference to the drawing.

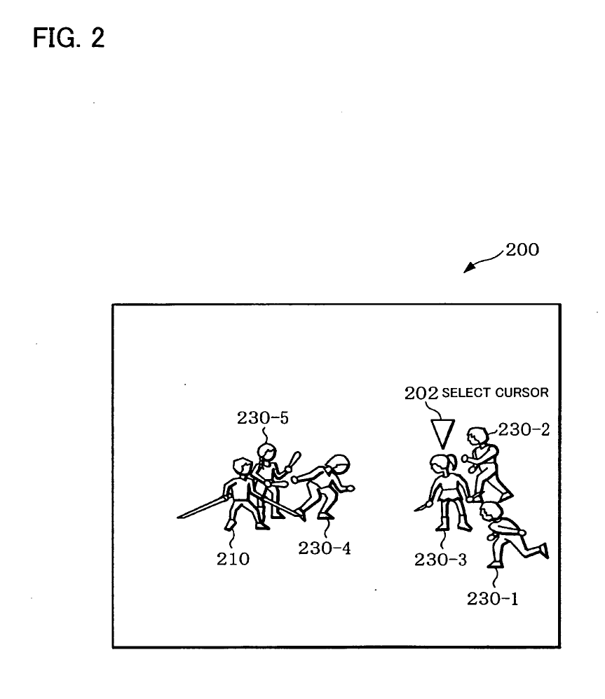

FIG. 2 is a diagram for illustrating the selection of a target character according to one embodiment of the present invention.

A game image is denoted by 200; a player character controlled by a player is denoted by 210; and 230-1 to 230-5 show enemy characters against the player character. This embodiment is designed to permit the player character to attack a target character which is selected from a group of enemy characters 230-1 to 230-5.

The player can select the desired target character by performing predetermined selecting and operating inputs through the operating section.

For example, the player may sequentially move a select cursor 202 to the respective one of the enemy characters by performing a first operation through the operating section and may set the desired enemy character pointed by the select cursor as a target character.

The player may sequentially move a select cursor 202 to the respective one of the enemy characters by performing the first operation through the operating section and then perform a second operation when the select cursor points the desired enemy character so that the enemy character pointed by the select cursor 202 will be set as a target character.

When a target character has been set, the game system enters a battle mode in which the player character battles against the set target character.

The general RPGs are frequently designed so that once a target (enemy) character has been selected, the player character automatically attacks that enemy character and that the player cannot interactively concern the attacking action of the player character.

On the contrary, this embodiment has such a feature that the player can interactively concern the attacking action of the player character without need of any complicated operation as in the action games, even after the target character has been selected (or even in the battle mode).

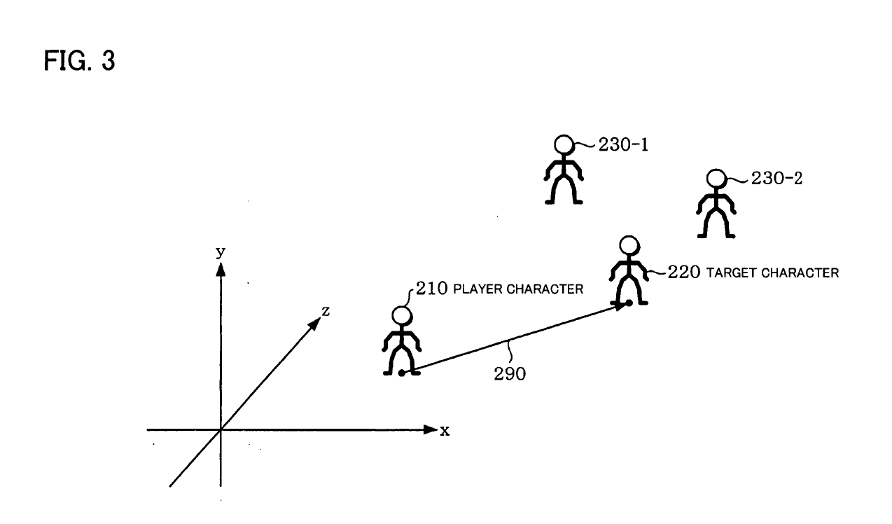

FIG. 3 is a diagram for illustrating characteristics of one embodiment of the present invention.

FIG. 3 shows that the player character 210 and target characters exist in a virtual three-dimensional game space and that a route is set between the player character 210 and a target character.

In this embodiment, when a target character has been set, a route 290 connecting the player character 210 and the set target character 220 within the three-dimensional game space is determined.

And, this embodiment receives operational inputs for controlling the game action of the player character 210 and causes the player character 210 to interactively perform the game action on the route based on the received operational inputs, even after the target character 220 has been set.

If the position of the target character varies for each frame, the route 290 is reset for the corresponding frame, based on the positional information for the player and target characters.

The route connecting the player character and the target character may be determined based on the positional information for the player and target characters in the last frame and this positional information for the player character may be determined on that route at any position.

The game action may include predetermined attacks or actions made by the player character, cancellation of the predetermined attacks or actions, additional attacks or actions and so on.

For example, the player character may be moved in default on the route 290 after a target character has been set. Then, the player may perform the operational input to instruct a timing at which the player character attacks the target character, for example, with a sword (an example of the predetermined attacks). In this case, the player character cannot knock the target character down if the timing is wrong (e.g., if the player performs the operational input to swing its sword when the target character does not exist within a hit checking range for the sword of the player character).

Basically, the player character moves on the route 290 set by the system. This is because if the game is designed such that the player character can freely be controlled in the three-dimensional space through the operational inputs, the operation system becomes too complicated so that a person weak on the action games cannot enjoy the game.

In such a manner, the battle mode in this embodiment ensures that the player can perform the operational inputs to interactively control the player character such that it makes to make predetermined attacks or actions, cancellation of the predetermined attacks or actions and additional attacks or actions on the route 290.

According to the present invention, furthermore, the movement of the player character on the route connecting the player and target characters can automatically be controlled by the system. Therefore, the player will not be required to control the route on which the player character moves.

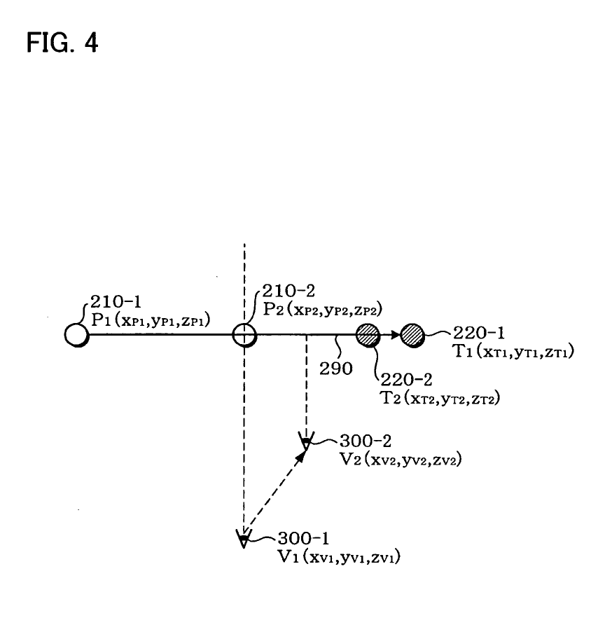

FIG. 4 is a diagram for illustrating the placement control of the virtual camera according to one embodiment of the present invention.

Even in the battle mode (or a mode wherein after a target character has been set, the player character battles against the set target character), this embodiment acquires the positions of the player and target characters in real time, and determines the position and orientation (placement) of the virtual camera based on the acquired positions.

If it is now assumed that in the first frame, the positional coordinates of the player character 210-1 is PI (xₚ₁, yₚ₁, zₚ₁) and the positional coordinates of the target character is T1 (x_{T1}, y_{T1}, z_{T1}), the positional coordinates V1 (x_{T1}, y_{T1}, Z_{T1}) of the virtual camera in the first frame is determined based on the positional coordinates P1 (xₚ₁, yₚ₁, zₚ₁) and T1 (x_{T1}, y_{T1}, z_{T1}) acquired in real time.

If it is also assumed, for example, that in the second frame, the positional coordinates of the player character 210-2 is P2 (xₚ₂, yₚ₂, zₚ₂) and the positional coordinates of the target character is T2 (x_{T2}, y_{T2}, z_{T2}), the positional coordinates V2 (x_{T2}, y_{T2}, z_{T2}) of the virtual camera in the second frame is determined based on the positional coordinates P2 (xₚ₂, yₚ₂, zₚ₂) and T2 (x_{T2}, y_{T2}, z_{T2}) acquired in real time.

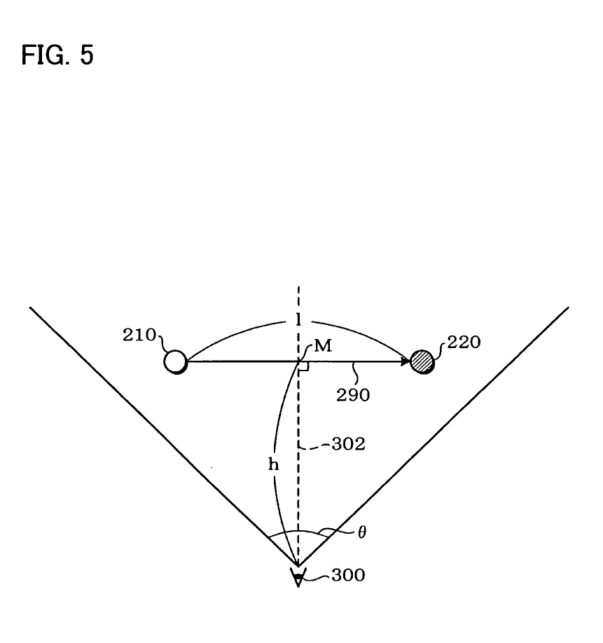

FIG. 5 is a diagram for illustrating a placement example of the virtual camera according to one embodiment of the present invention.

The positional information of the virtual camera 300 is calculated so that it is disposed at a position in which the virtual camera 300 can easily view both the player and target characters. The positional information of the virtual camera may include only the positional coordinates of the virtual camera or may also include the orientation of the virtual camera.

The position in which the virtual camera can easily view both the player and target characters may be a predetermined point on a straight line 302 which orthogonally intersect a line segment (e.g., the route 290) connecting the player character 210 and the target character at the midpoint M of the line segment (the point is spaced apart from the midpoint M by a distance h in FIG. 5), for example.

The distance h may be determined in consideration of the length l of the line segment 290 connecting the player character 210 and the target character, or the angle of view θ of the virtual camera.

The straight line 302 may be one passing in the vicinity of the middle point M or may be substantially perpendicular to the line segment 290.

If the positions of the player and target characters 210, 220 have varied, the virtual camera may be moved so that it is located in a predetermined position on the straight line 302 orthogonally intersecting the line segment 290 at its middle point M. In this case, to implement a smooth movement, the virtual camera may not necessarily be moved to the predetermined position on the straight line 302 orthogonally intersecting the line segment 290 at its middle point M.

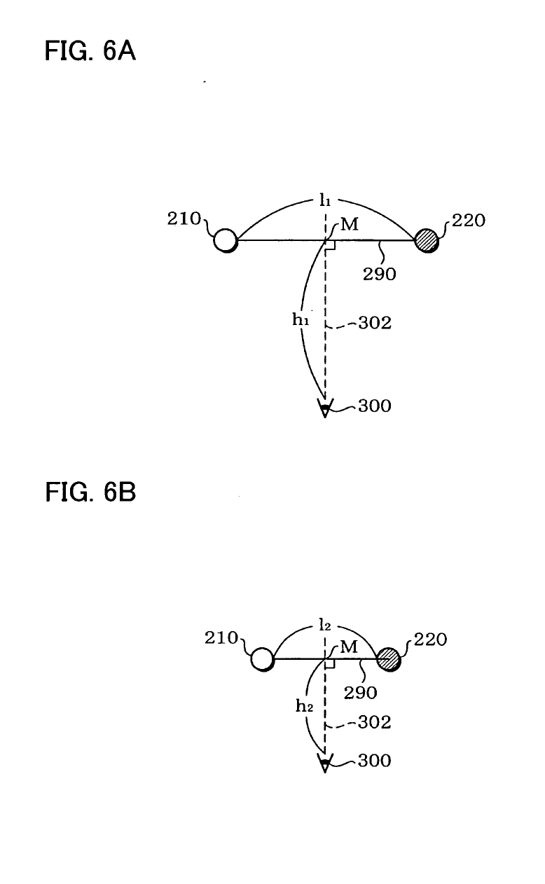

FIGS. 6A and 6B are diagrams for illustrating zooming processing of the virtual camera according to one embodiment of the present invention.

FIG. 6A illustrates a position of the virtual camera (or a point spaced apart from M by a distance h₁) when the player character 210 is located spaced apart from the target character 220 by a distance l₁ while FIG. 6B illustrates another position of the virtual camera (or a point spaced apart from M by a distance h₂) when the player character 210 is located spaced apart from the target character 220 by a distance l₂. In this case, l₁>l₂ and h₁>h₂.

The position of the virtual camera may be controlled such that if l₁>l₂, h₁>h₂ is provided.

In such a case, the virtual camera can be located at a zoomed-up (enlarged) position as the distance between the player and target characters 210, 220 decreases. On the other hand, the virtual camera can be disposed at a zoomed-back (reduced) position as the distance between the player and target characters 210, 220 increases.

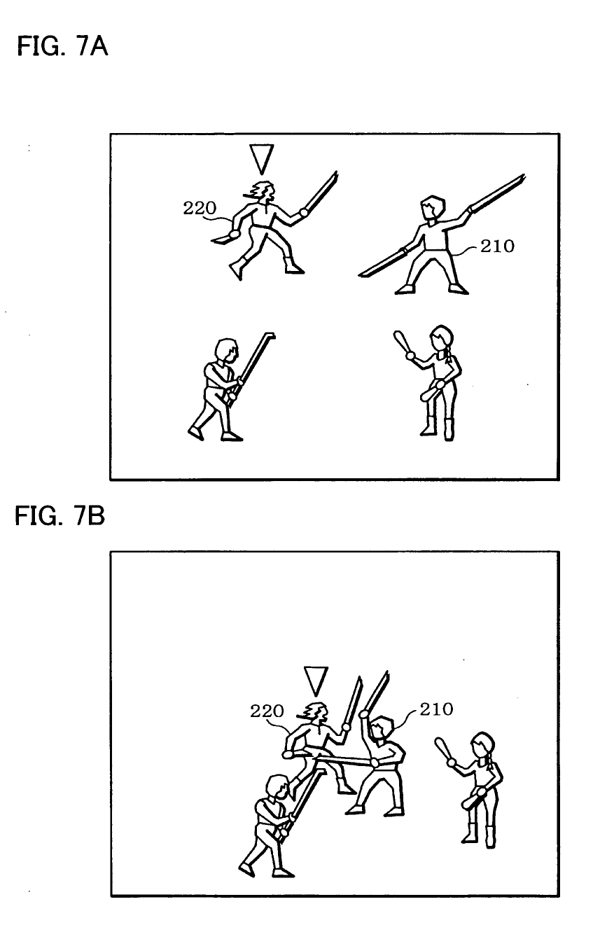

FIGS. 7A and 7B are diagrams showing examples of game images when zooming processing is performed according to one embodiment of the present invention. FIG. 7B shows a zoomed-up state since the distance between the player and target characters 210, 220 decreases in comparison with FIG. 7A.

Another zooming technique may be used in which when the distance between the characters varies from l₁ to l₂, the position of the virtual camera is not changed so that the angle of view θ decreases while maintaining the distance h₁.

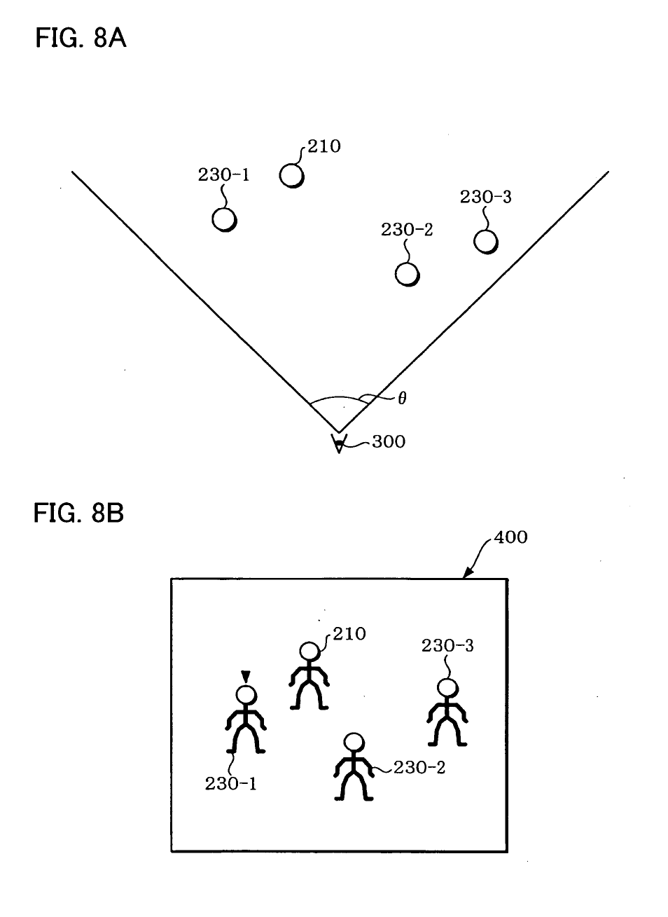

FIGS. 8A and 8B are diagrams for illustrating the placement control of the virtual camera in a select mode.

In this embodiment, the virtual camera is disposed at a position wherein it can view all the selectable target characters in a target character select mode in which one of the target characters can be selected. In other words, the virtual camera 300 may be disposed in a position wherein all the enemy (or selectable) characters 230-1 to 230-3 are located within the angle of view θ in the virtual camera 300 as shown in FIG. 8A.

Thus, such a game image as shown in FIG. 8B can be generated in which all the enemy (or selectable) characters 230-1 to 230-3 are displayed on the screen.

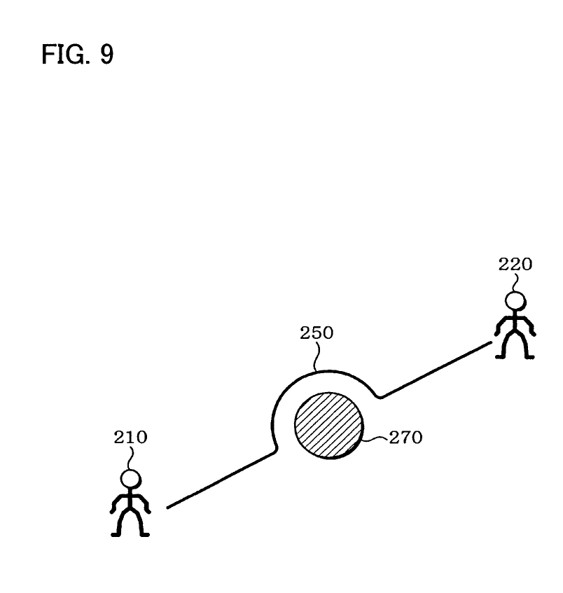

FIG. 9 is a diagram showing another example of the route connecting a player character and a target character.

If there is an obstacle 270 between the player and target characters 210, 220 in the three-dimensional game space, a route 250 avoiding the obstacle 270 may be set.

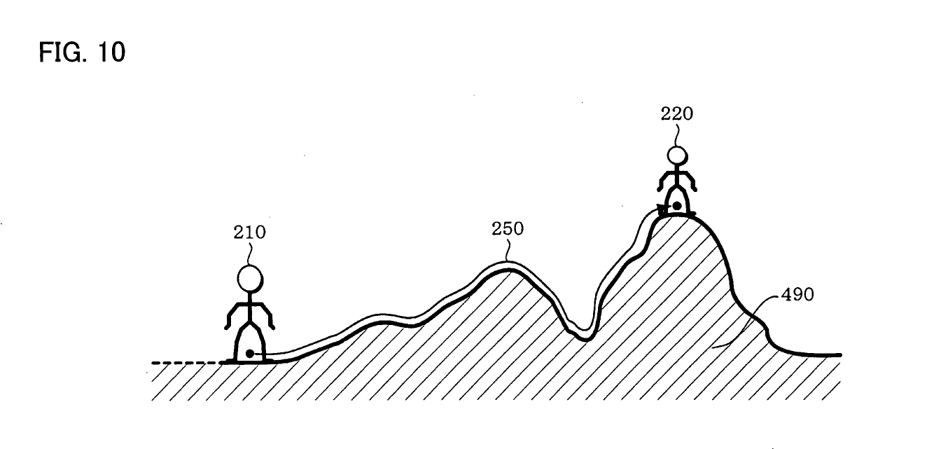

FIG. 10 is a diagram showing a further example of the route connecting a player character and a target character.

If there is a height difference between the player and target characters 210, 220 within the three-dimensional game space (in this figure, there is a ground level difference in a landform 490), a route 250 reflecting the height difference may be set. In this figure, the route 250 is set in consideration of the ground level difference in the landform 490. More particularly, z-value in a point (x, y, z) on the route can be determined to reflect the height difference.

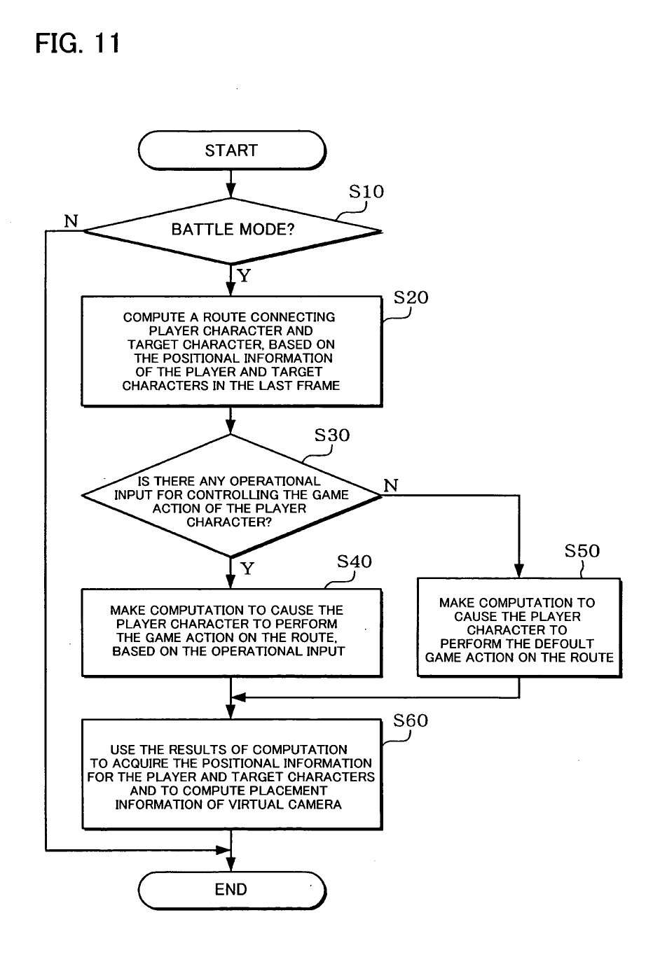

FIG. 11 is a flow chart illustrating processing according to one embodiment of the present invention.

In the battle mode, the following processing is carried out (step S10). The battle mode is one wherein a player selects a target character from enemy characters and causes the player character to battle against the selected enemy character.

First of all, a route connecting the player and target characters is determined based on the positional information for the player and target characters in the last frame (step S20).

Next, if an operational input for controlling the game action from the player is detected, a computation for causing the player character to perform the game action on the route is carried out based on the operational input (steps S30 and S40). This computation for the game action may include a computation for the position of the player character, a computation for rotation, a computation for motion and so on.

If an operational input for controlling the game action from the player is not detected, a computation for causing the player character to act on the route in default (steps S30 and S50).

The results of computation are then used to acquire the positional information for the player and target characters and to compute the placement information of the virtual camera (step S60).

A game image viewed from the virtual three-dimensional game space is then generated, based on the placement information.

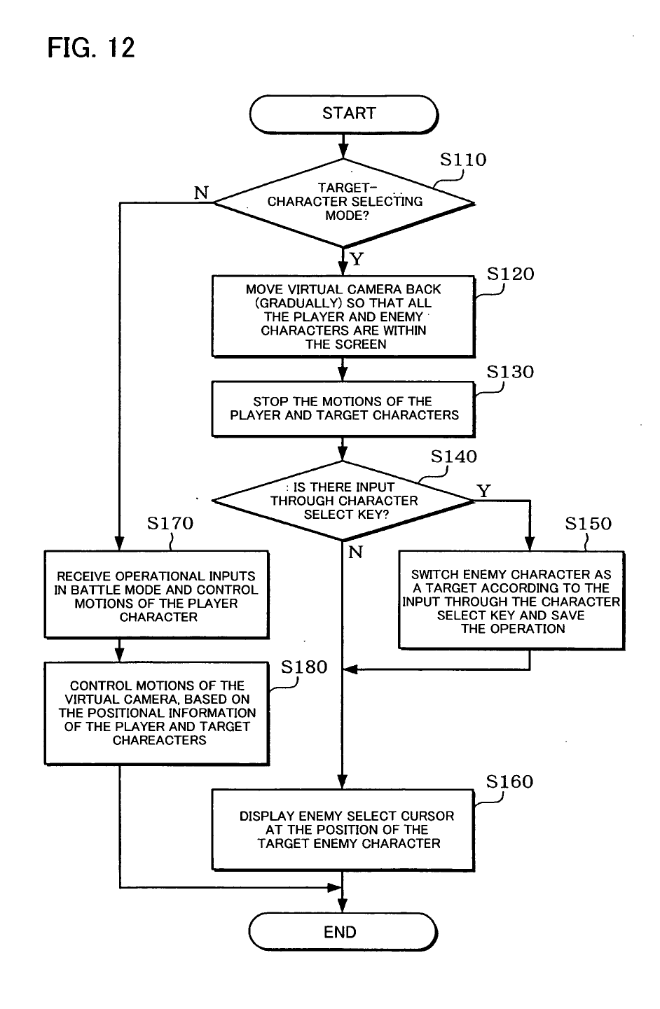

FIG. 12 is a flow chart for illustrating the placement control of the virtual camera according to one embodiment of the present invention.

It is first judged whether or not the system is in a target character selecting mode (step S110).

The target character select mode is one that selects a target or enemy character.

If the system is in the target character select mode, the virtual camera is gradually moved back such that all of the player and enemy characters are located within the screen (step S120).

Next, the motions of the player and enemy characters are then stopped (step S130).

If there is an input for character selection at this point, the enemy character as a target is switched and that operation is saved (steps S140 and S150).

The position of the target or enemy character is set and displayed together with a cursor for enemy selection (step S160).

If the system is not in the target select mode, operational inputs usable in the battle mode are received to control the motion of the player character. For example, operational inputs for controlling the game action of the player character may be received; the received operational inputs may be used to interactively control the game action of the player character on the route; and the position, rotation (orientation) and motion of the player character may be computed.

The motion of the virtual camera is then controlled based on the positional information for the player and target characters (step S180). The position of the virtual camera and the rotational information (or placement information) of the same are then computed based on the positional information of the player and target characters. The virtual camera is then placed based on the computed placement information.

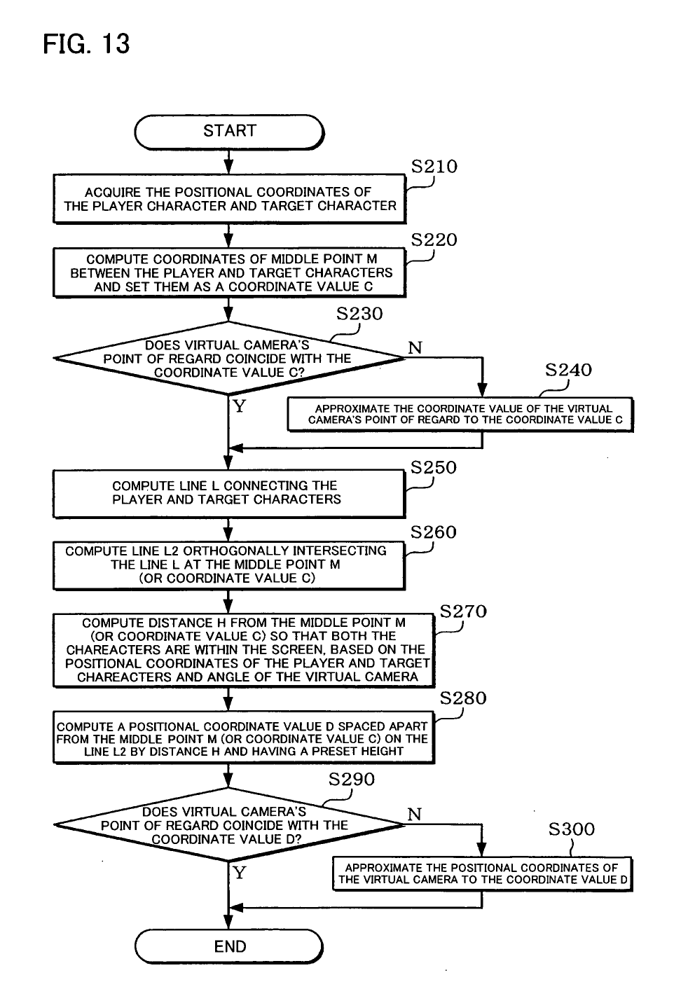

FIG. 13 is a flow chart for illustrating action control of the virtual camera in the battle mode.

Positional coordinates of the player and target characters are first acquired (step S210).

Positional coordinates of a middle point between the positional coordinates of the player character and the positional coordinates of the target character is then computed to set a coordinate value C (step S220).

Next, if the virtual camera's point of regard is not the same as the coordinate value C, the rotational information of the virtual camera is then determined so that the coordinate value of the virtual camera's point of regard approximates the coordinate value C (steps S230 and S240).

Next, a line L connecting the positions of the player and target characters is then computed (step S250).

Another line L₂ orthogonally intersecting the line L and passing through the middle point M (or coordinate value C) thereon is computed (step S260).

A distance H from the middle point M (or coordinate value C) is then computed so that both the player and target characters are located within the screen, based on the positional coordinates of the player and target characters and the angle of view in the virtual camera (step S270).

The coordinates of a position D spaced apart from the middle point M (or coordinate value C) on the line L₂ by the distance H and having a preset height is then computed (step S280).

If the positional coordinates of the virtual camera (or the positional coordinates of the virtual camera in the last frame) is not the same as the coordinate value D, the positional coordinates of the virtual camera are determined so that they approximate the coordinate value D (steps S290 and S300).

3. Hardware Configuration

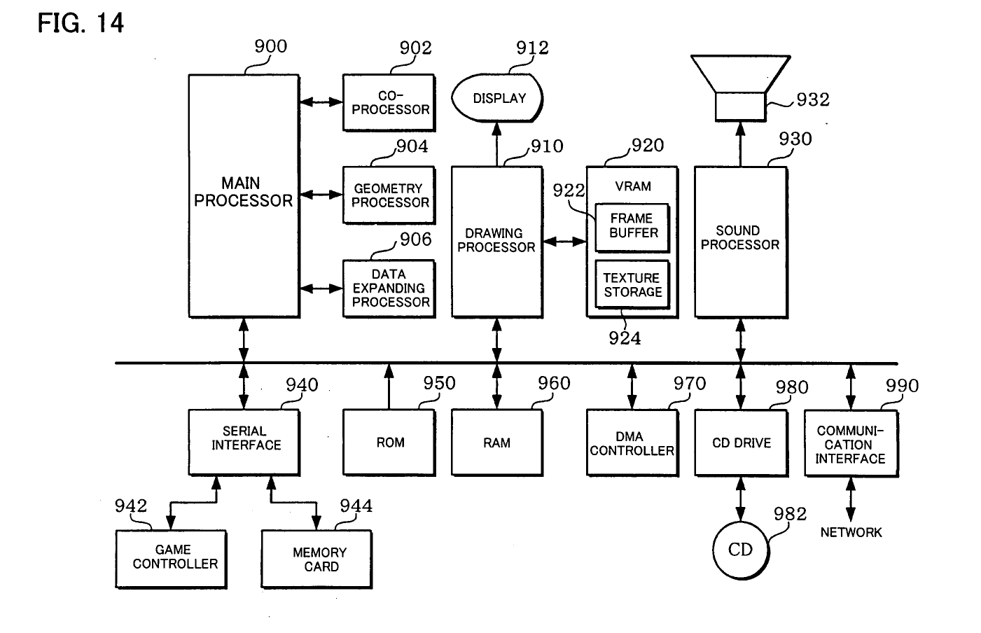

The hardware configuration for implementing one embodiment of the present invention will be described with reference to FIG. 14.

A main processor 900 operates to perform various types of processing such as game processing, image processing, sound processing and other processing according to a program stored in a CD (information storage medium) 982, a program transferred through a communication interface 990 or a program stored in a ROM (one of the information storage media) 950.

A co-processor 902 assists the processing of the main processor 900 and has a product-sum operator and a divider which can perform high-speed parallel calculation to perform a matrix (or vector) calculation at high speed. For example, if a physical simulation for causing an object to move or act (motion) requires the matrix calculation or the like, the program running on the main processor 900 instructs (or asks) the processing to the co-processor 902.

A geometry processor 904 performs a geometry processing such as coordinate transformation, perspective transformation, light source calculation, curve formation or the like and has a product-sum operator and a divider which can perform high-speed parallel calculation to perform a matrix (or vector) calculation at high speed. For example, if the coordinate transformation, perspective transformation, a light source calculation and the like are to be carried out, the program running on the main processor 900 instructs the processing to the geometry processor 904.

A data expanding processor 906 performs a decoding process for expanding compressed image and sound data or a process for accelerating the decoding process in the main processor 900. Thus, moving images compressed by MPEG method or the like can be displayed in the opening, intermission, ending or game images. The image and sound data to be decoded may be stored in ROM 950 and/or CD 982 or may externally be transferred through the communication interface 990.

A drawing processor 910 draws or renders an object constructed by primitive faces such as polygons or curved surfaces at high speed. On drawing of an object, the main processor 900 uses the function of a DMA controller 970 to deliver the object data to the drawing processor 910 and at the same time, transfers the texture to a texture storage section 924, if necessary. Then, the drawing processor 910 draws the object in a frame buffer 922 at high speed while performing the hidden-surface removal by the use of a Z buffer or the like, based on these object data and texture. The drawing processor 910 can also perform a-blending (or translucency processing), depth cueing, MIP-mapping, fog processing, bi-linear filtering, try-linear filtering, anti-aliasing, shading and so on. As the image for one frame has been written into at the frame buffer 922, that image is then displayed on a display 912.

A sound processor 930 includes a multi-channel ADPCM sound source or the like for generating high-quality game sounds such as BGMs, effect sounds, voices and the like. The generated game sounds are then output through a speaker 932.

Operation data from a game controller 942 and saved data and personal data from memory card 944 are transferred through a serial interface 940.

A ROM 950 stores a system program and so on. In arcade game systems, ROM 950 functions as an information storage medium for storing various programs. A hard disk may be used instead of the ROM 950.

A RAM 960 is used as a working area for various processors.

A DMA controller 970 controls DMA transfer between the processors and the memories (RAM, VRAM, ROM and the like).

A CD drive 980 drives the CD (or information storage medium) 982 stored programs, image data or sound data to enable access to these programs and data.

A communication interface 990 is one for performing data transfer between the game system and any external instrument through a network. In this case, a network connecting to the communication interface 990 may include a telecommunication line (such as analog telephone line or ISDN) and a high-speed serial bus. Data transfer can be carried out through Internet by using the telecommunication line. If a high-speed serial bus is used, the data transfer can be carried out between game systems.

All the means of this embodiment may be implemented only through hardware or only through a program stored in an information storage medium or a program distributed through the communication interface. Alternatively, they may be implemented through both the hardware and program.

If all the means of the present invention are implemented through both the hardware and program, an information storage medium stores a program for implementing the means of the present invention by hardware. More particularly, the aforementioned program instructs the processing to hardware such as the processors 902, 904, 906, 910 or 930, and delivers the data to them, if necessary. Each of the processors 902, 904, 906, 910, 930 and so on will implement the corresponding one of the means of the present invention, based on the instructions and delivered data.

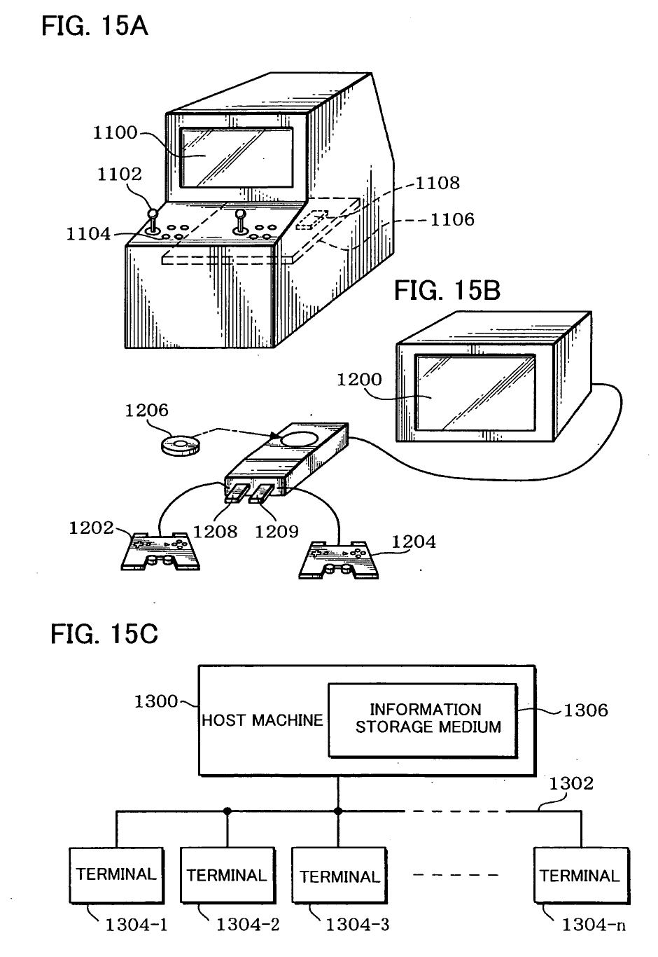

An arcade game system to which this embodiment is applied is shown in FIG. 15A. A player enjoys a game by manipulating a lever 1102, buttons 1104 and the like while viewing a game image displayed on a display 1100. A system board (or circuit board) 1106 included in the game system includes various processors and memories which are mounted thereon. The information (program or data) for implementing the means of the present invention is stored in a memory 1108 (or information storage medium) on a system board 1106. This information will be referred to as “stored information”.

A home game system to which this embodiment is applied is shown in FIG. 15B. Players enjoy a game by operating controllers 1202 and 1204 while viewing a game image displayed on a display 1200. In this case, the aforementioned stored information is in a removable information storage medium to the main body system, such as a CD 1206 or each memory card 1208 or 1209.

FIG. 15C shows an example wherein this embodiment is applied to a game system which includes a host machine 1300 and terminals 1304-1 to 1304-n connected to the host machine 1300 through a network (which is a small-scale network such as a local area network or a global network such as the Internet) 1302. In this case, the aforementioned stored information is in an information storage medium 1306 controllable by the host machine 1300, such as a magnetic disc device, magnetic tape device, memory and so on. If each of the terminals 1304-1 to 1304-n can generate game images and sounds in the standalone manner, a game program and the like for generating game images and sounds will be delivered from the host machine 1300 to that terminal. On the other hand, if each of the terminals cannot generate the game images and sounds in the standalone manner, the host machine 1300 generates game images and sounds which are in turn transmitted to that terminal.

In the configuration of FIG. 15C, the means of the present invention may be distributed to and carried out by a host machine (or server) and terminals. The aforementioned stored information for implementing the means of the present invention may be distributed to and stored in the information storage media of the host machine (server) and terminals.

Each of the terminals connecting to the network may be either of a home game system or an arcade game system. If an arcade game system is connected with a network, it is desirable to use an information saving device (memory card or mobile game device) which can deliver information between the information saving device and the arcade game systems and between the information saving device and home game systems.

Note that this invention is not limited to the embodiments thereof described above and thus it can be implemented in many various ways.

Part of requirements of any claim of the present invention could be omitted from a dependent claim which depends on that claim. Moreover, part of requirements of any independent claim of the present invention could be made to depend on any other independent claim.

The present invention is not limited to such a case that a target character is selected from a group of enemy characters. For example, a friend character may be selected as a target character.

Furthermore, the present invention is not limited to such a case that a target character is attacked (or in the attack mode). For example, after a target character has been set, actions other than the attack action (such as communication or progress) may be performed.

Furthermore, the present invention is not limited to such a case that a target character is selected from enemy characters. For example, a target character may be selected from friend characters.

Furthermore, the virtual camera may be disposed at a location viewing the player and target characters from just beside so that the direction of the target character from the player character is the forward direction in commands inputted by the player through a controller.

In addition, the present invention is not limited to such a case that the target character selecting information is provided by the operational input from the player. For example, the target character selecting information may automatically be determined by the system.

The present invention can be applied to various action or role playing games.

The present invention can be applied to various game systems such as arcade game systems, home game systems, large-scale attraction system in which a number of players play a game, simulators, multimedia terminals, system boards for generating game images and so on.

1. A method of controlling a game system for a three-dimensional role playing game in which a plurality of characters including a player character appear, the method comprising:
receiving select information of a target character which is a target of battle or a target of movement for the player character to determine the target character based on the select information;
controlling an action of the player character to battle against or to move toward the determined target character; and
generating a game image in which the player character and the target character are shown;
wherein the step of controlling an action of the player character includes:
determining a route connecting the player character and the target character within a three-dimensional game space; and
receiving operational input information for controlling a game action of the player character, and interactively controlling a game action of the player character based on the operational input information so that the player character performs a game action on the route.

2. The method as defined in claim 1,
wherein as an operational input for controlling a game action of the player character, an operational input for a predetermined attack or motion, cancellation of an attack or motion, or addition of an attack or motion is received, and a game action of the player character is interactively controlled based on the received operational input so that the player character performs a predetermined attack or motion, cancellation of an attack or motion, or addition of an attack or motion on the route.

3. The method as defined in claim 1, further comprising:
a virtual camera control step for acquiring positions of the player character and the target character in real time and for controlling placement of a virtual camera based on the acquired positions of the player character and the target character.

4. The method as defined in claim 1, further comprising:
a virtual camera control step for controlling placement of a virtual camera based on information of the route connecting the player character and the target character.

5. The method as defined in claim 3,
wherein in the virtual camera placement control step, positional information of the virtual camera is calculated so that the virtual camera is disposed at a position in which the player character and the target character are easily viewed by the virtual camera.

6. The method as defined in claim 3,
wherein in the virtual camera placement control step, a distance between the player character and the target character is calculated based on positional information of the player character and the target character, and zooming is performed depending on the distance.

7. The method as defined in claim 3,
wherein in the virtual camera placement control step, positional information of a virtual camera is calculated so that the virtual camera is disposed at a position in which all selectable characters are viewed by the virtual camera when a target character is selected.

8. The method as defined in claim 1,
wherein the route is set as a straight line connecting the player character and the target character within the three-dimensional game space.

9. The method as defined in claim 1,
wherein when an obstacle exists between the player character and the target character within the three-dimensional game space, the route is set to avoid the obstacle.

10. The method as defined in claim 1,
wherein when height difference exists between the player character and the target character within the three-dimensional game space, the route is set to reflect the height difference.

11. A program capable of causing a computer to perform a three-dimensional role playing game in which a plurality of characters including a player character appear, the program causing the computer to implement:
a target character determination section which receives select information of a target character which is a target of battle or a target of movement for the player character to determine the target character based on the select information;
a player character action control section which controls an action of the player character to battle against or to move toward the determined target character; and
an image generation section which generates a game image in which the player character and the target character are shown,
wherein the player character action control section includes:
a route determination section which determines a route connecting the player character and the target character within a three-dimensional game space; and
a game action control section which receives operational input information for controlling a game action of the player character, and interactively controls a game action of the player character based on the operational input information so that the player character performs a game action on the route.

12. The program as defined in claim 11,
wherein as an operational input for controlling a game action of the player character, an operational input for a predetermined attack or motion, cancellation of an attack or motion, or addition of an attack or motion is received, and a game action of the player character is interactively controlled based on the received operational input so that the player character performs a predetermined attack or motion, cancellation of an attack or motion, or addition of an attack or motion on the route.

13. The program as defined in claim 11, causing the computer to further implement:
a virtual camera placement control section which acquires positions of the player character and the target character in real time and controls placement of a virtual camera based on the acquired positions of the player character and the target character.

14. The program as defined in claim 11, causing the computer to further implement:
a virtual camera placement control section which controls placement of a virtual camera based on information of the route connecting the player character and the target character.

15. The program as defined in claim 13,
wherein the virtual camera placement control section calculates positional information of the virtual camera so that the virtual camera is disposed at a position in which the player character and the target character are easily viewed by the virtual camera.

16. The program as defined in claim 13,
wherein the virtual camera placement control section performs zooming depending on a distance between the player character and the target character calculated based on positional information of the player character and the target character.

17. The program as defined in claim 13,
wherein the virtual camera placement control section calculates positional information of a virtual camera so that the virtual camera is disposed at a position in which all selectable characters are viewed by the virtual camera when a target character is selected.

18. The program as defined in claim 11,
wherein the route is set as a straight line connecting the player character and the target character within the three-dimensional game space.

19. The program as defined in claim 11,
wherein when an obstacle exists between the player character and the target character within the three-dimensional game space, the route is set to avoid the obstacle.

20. The program as defined in claim 11,
wherein when height difference exists between the player character and the target character within the three-dimensional game space, the route is set to reflect the height difference.

21. Computer-readable information storage medium storing the program as defined in claim 11.

22. A game system for a three-dimensional role playing game in which a plurality of characters including a player character appear, the game system comprising:
a target character determination section which receives select information of a target character which is a target of battle or a target of movement for the player character to determine the target character based on the select information;
a player character action control section which controls an action of the player character to battle against or to move toward the determined target character; and
an image generation section which generates a game image in which the player character and the target character are shown,
wherein the player character action control section includes:
a route determination section which determines a route connecting the player character and the target character within a three-dimensional game space; and
a game action control section which receives operational input information for controlling a game action of the player character, and interactively controls a game action of the player character based on the operational input information so that the player character performs a game action on the route.
